(19) United States
(12) Patent Application Publication
(10) Pub. No.: US 2015/0308334 A1
(43) Pub. Date: Oct. 29, 2015

(54) DRIVELINE ASSEMBLY FOR RADIATOR FAN DRIVE

(71) Applicant: Caterpillar Inc., Peoria, IL (US)

(72) Inventors: RYAN D. OEDEWALDT, Bartonville, IL (US); JEFFERY L. SCHELL, Fayetteville, GA (US); DEEPAK B. THAKKAR, Peoria, IL (US); RAMA K. NANDAMURI, Dunlap, IL (US); BHANU K. MOTURI, Griffin, GA (US); SUNIL B. KOLLABHATTULA, Peoria, IL (US); MATTHEW L. BROWN, Otterbein, IN (US)

(73) Assignee: Caterpillar Inc., Peoria, IL (US)

(21) Appl. No.: 14/792,646

(22) Filed: Jul. 7, 2015

(51) Int. Cl. F02B 67/06; F16D 3/64

(52) U.S. Cl. CPC F02B 67/06; F16D 3/64

(57) ABSTRACT

A driveline assembly for an engine is disclosed. The engine has an engine damper and a base frame. The engine is mounted on the base frame. The driveline assembly includes a torsional coupling that has alternating wedge portions of first wedge portions and second wedge portions. The first wedge portions include a rigid structure. The second wedge portions include a resilient structure. A guide assembly includes at least one pillow block mounted to the base frame. Further, a driveshaft is included that has a first end and a second end. The first end is connected to the engine damper via the torsional coupling. The driveshaft is rotatably supported by the pillow block. Moreover, the first wedge portions include radially extending fasteners to capture an outer portion of the first end of the driveshaft. Further, a belt drive with a drive pulley is connected to the second end of the driveshaft.

### TECHNICAL FIELD

The present disclosure relates generally to radiator fan drive units in relatively large-scale engine applications. More specifically, the present disclosure relates to a radiator fan drive that utilizes a non-cardan, substantially linearly configured shaft design, to drive a radiator fan drive unit.

### BACKGROUND

Internal combustion engines used in marine applications are known to employ relatively large-sized fans to cool a radiator when compared to an automotive application. Due to size constraints, these fans are typically remotely mounted from the engine and are in close proximity of the radiator. A driveline assembly is typically used to transmit the engine power to drive the radiator-cooling fan.

In detail, driveline assemblies in large-scale power systems, utilizing a fan on radiator design, generally incorporate a cardan shaft. Cardan shafts commonly include a split-shaft configuration with at least one universal coupling interposed between the split shafts. Such configurations pose challenges with alignment and an efficient assembly of the driveline assembly with the engine. This is because cardan shafts may be non-linear in their profile, and may inherently include more than one axis. Therefore, employment of the cardan shaft requires the engine and the radiator to be assembled at the same time. This is generally tedious and time-consuming Moreover, spatial constraints may worsen the situation. Additionally, inappropriate assembly may lead to breakage of the cardan shaft during operation, and, thus, cause undue machine down time. Therefore, systems applied in such relatively large-scale engine applications, typically suffer from considerable inefficiency given improper mounting and assembly of the driveline assembly to the engine.

U.S. Pat. No. 1,265,086 discloses an attachable support mountable to an engine of an automobile. This reference sets forth a support, which may be attached directly to an engine base and extends between a front of the automobile and the engine. Since this support is for use in a confined space, the alignment between the engine and the fan is generally critical, and, therefore, a support-fan assembly would still likely require to be first assembled, prior to the installation of the engine-fan assembly, into a body of the automobile.

Accordingly, the system and method of the present disclosure solves one or more problems set forth above and/or other problems in the art.

### SUMMARY OF THE INVENTION

Various aspects of the present disclosure illustrates a driveline assembly for an engine. The engine has an engine damper and a base frame to which the engine is mounted. A torsional coupling is included, which has alternating wedge portions. The alternating wedge portions include first wedge portions with a rigid structure and second wedge portions with a resilient structure. A guide assembly includes at least one pillow block mounted to the base frame. Further, the driveline assembly includes a driveshaft with a first end and a second end. The driveshaft is connected at a first end to the engine damper. The first end is connected to the engine damper via the torsional coupling. In addition, the driveshaft is rotationally supported by the pillow block. The first wedge portions include radially extending fasteners to capture an outer portion of the first end of the driveshaft. Moreover, a belt drive with a drive pulley is connected to the second end of the driveshaft.

### BRIEF DESCRIPTION OF THE DRAWINGS

FIG. 1 is a driveline assembly, in accordance with the concepts of the present disclosure;

FIG. 2 is an exploded view of an exemplary driveline assembly depicted in FIG. 1, in accordance with the concepts of the present disclosure; and.

FIG. 3 is a perspective view of a flexible coupling of the driveline assembly shown in FIG. 2, in accordance with the concepts of the present disclosure.

### DETAILED DESCRIPTION

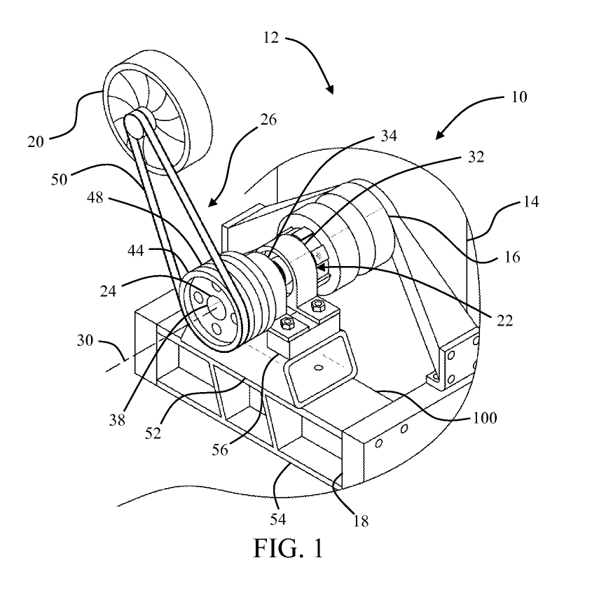

FIG. 1 shows an exemplary driveline assembly 10 that is employed in an engine system 12, according to the present disclosure. The engine system 12 includes an engine 14 with an engine damper 16. The engine damper 16 is driven by the engine 14. The engine 14 may be an internal combustion engine applied to carry out relatively large-scale power applications. As an example, such applications may be associated with marine environments. However, a variety of other environments may be contemplated. For example, an application of the aspects of the present disclosure may be envisioned in construction machines, generators, and other power-generating units, employed commercially and domestically. Generally, the engine 14 is fixedly mounted to a base frame 18, as shown.

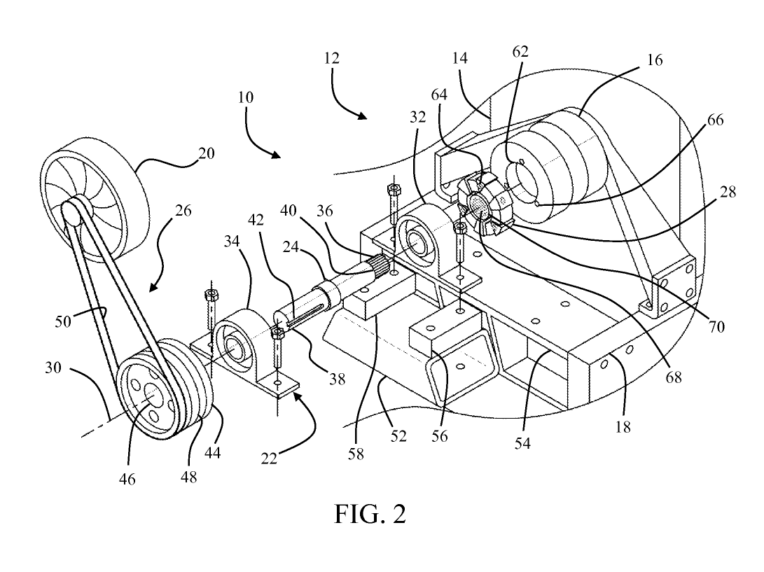

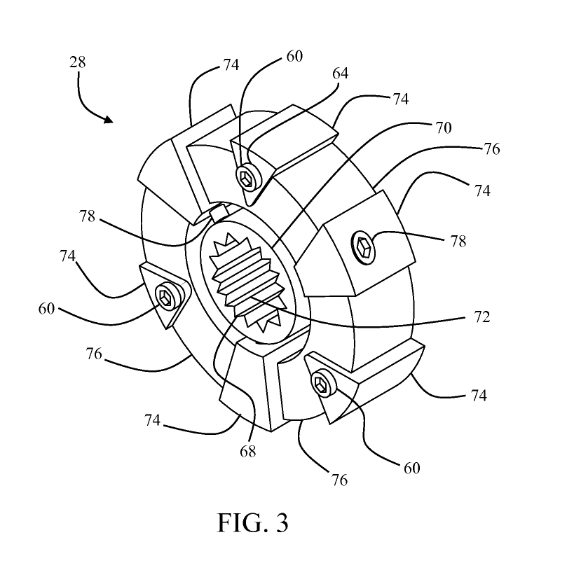

The driveline assembly 10 is configured to drive a radiator fan 20 of the engine 14. The driveline assembly 10 includes a guide assembly 22, a driveshaft 24, and a belt drive 26, and a flexible coupling, which may also be referred to as a torsional coupling 28 (FIGS. 2 and 3). Each of these components and/or sub-systems work in concert to effectively drive the belt drive 26, and, thus, the radiator fan 20. Further, each of these components and/or sub-systems are positioned substantially operably inline to the engine damper 16. In so doing, a longitudinal axis 30 runs co-axially through each of the components and/or sub-systems. The radiator fan 20 may be directed to force air through a radiator (not shown) in order to cause cooling of a coolant that circulates through the engine 14 to effectuate operation under optimal temperature conditions. Further, the driveline assembly 10 and the engine 14 are mounted to the same base frame 18. This enables the driveline assembly 10 to be in direct and reliable engagement with the engine damper 16.

Referring to FIG. 2, the guide assembly 22 is positioned adjacent to the engine damper 16. The guide assembly 22 includes two pillow blocks, namely, a first pillow block 32 and a second pillow block 34, or simply pillow blocks 32 and 34, for ease of reference. However, an application involving use of a singular pillow block may be contemplated as well.

The first pillow block 32 is a bearing housing with a configuration that includes a pedestal platform, as is customarily known. The pedestal platform facilitates a deployment and an inflexible fitting of the first pillow block 32, assumed through a bolted or a riveted configuration, to the base frame 18. In so doing, the first pillow block 32 may ascertain an immovable relation with the engine damper 16.

The second pillow block 34 is similar in form, function, and assembly, to the first pillow block 32. Therefore, as with the first pillow block 32, the second pillow block 34 is also be mounted to the base frame 18. However, the second pillow block 34 is positioned inline to the first pillow block 32, as a series, along the longitudinal axis 30, and towards the belt drive 26. Together, the pillow blocks 32 and 34 and may function as a twin guide pedestal to rotatably support the driveshaft 24. For this purpose, pillow blocks 32 and 34 include bearings (not shown) that facilitate a rotatable accommodation of the driveshaft 24.

The driveshaft 24 may be a substantially linearly configured power-transmitting unit that facilitates transfer of rotary motion from the engine damper 16 to the belt drive 26. As already noted, the driveshaft 24 is rotatably positioned through the pillow blocks 32 and 34. The driveshaft 24 includes a first end 36 and a second end 38. The first end 36 is connected to the engine damper 16 and the second end 38 is connected to the belt drive 26. The driveshaft 24 is connected to the engine damper 16 at the first end 36 by the torsional coupling 28. The torsional coupling 28 sits as an interface between the driveshaft 24 and the engine damper 16. The engine damper 16 may be driven by a crankshaft (not shown) of the engine 14. In an embodiment, the engine damper 16 may form a damper group that forms a connection interface between the crankshaft (not shown) of the engine 14 and the driveshaft 24.

To this end, the driveshaft 24 includes a number of splined grooves 40 structured at the first end 36. The splined grooves 40 may be arrayed about an outer surface of the driveshaft 24, and may structurally extend along the longitudinal axis 30. Similarly, the second end 38 may include at least one keyway 42, into which a key (not shown) could be inserted. The key (not shown) may facilitate a fixed engagement of the driveshaft 24 to the belt drive 26 at the second end 38.

The belt drive 26 includes a drive pulley 44. The drive pulley 44 is inclusive of a shaft aperture 46 that provides a fixed accommodation to the second end 38 of the driveshaft 24. The shaft aperture 46 may include a key slot (not shown) to immovably accommodate the key (not shown) inserted into the keyway 42 of the second end 38 of the driveshaft 24. In so doing, the connection between the belt drive 26 and the driveshaft 24 is inflexibly established. Effectively, the driveshaft 24 is fixedly connected relative to both the engine damper 16 and the belt drive 26. Therefore, a rotation of the engine damper 16 corresponds to an operation of the belt drive 26. As with the driveshaft 24, and the pillow blocks 32 and 34, the drive pulley 44 is positioned substantially inline to the engine damper 16, along the longitudinal axis 30.

Further, a number of circumferential grooves 48 are defined on the drive pulley 44. The circumferential grooves 48 run peripherally along an outer circumference of the drive pulley 44. In the depicted embodiment, five circumferential grooves 48 are shown. However, a different number of circumferential grooves 48 is possible. Each circumferential groove 48 is structured sequentially along the longitudinal axis 30. Circumferential grooves 48 facilitate accommodation of one or more of a belt 50 that enables transmission of rotary motion of the drive pulley 44 to the radiator fan 20. Further, specifications and position of the belt 50 relative to the drive pulley 44 may vary from application to application. Given a multi-groove design, the drive pulley 44 may have the ability to shift a position of the radiator fan 20 longitudinally, along the longitudinal axis 30, and relative to the driveline assembly 10.

The base frame 18 includes a base member 52 and a frame section 54, as shown. The frame section 54 extends substantially transversally relative to the longitudinal axis 30. Alternate deployments of the frame section 54 may be contemplated. The base member 52 may be connected and mounted to the base frame 18 via the frame section 54. The base member 52 enables mounting of the driveline assembly 10 onto the base frame 18, so as to permit the driveline assembly 10 to be substantially robustly installed with the engine 14. Although not limited, all associated connections may be enabled by means of bolted and/or riveted fasteners. In an embodiment, the base member 52 and the frame section 54 may be integral to the base frame 18. Further, the base member 52 includes a first platform 56 and a second platform 58, onto which the pillow blocks 32 and 34, respectively, may be mounted during assembly.

The torsional coupling 28 is co-axially connected and aligned with the engine damper 16, about the longitudinal axis 30. The torsional coupling 28 is positioned adjacent to the first pillow block 32, and forms an interface between the first end 36 of the driveshaft 24 and the engine damper 16. However, the first pillow block 32 defines a minimal clearance with the torsional coupling 28, to comply with a rotation of the engine damper 16. As shown, the torsional coupling 28 is sequentially positioned along the longitudinal axis 30, and inline relative to pillow blocks 32 and 34 and the engine damper 16.

Referring to FIGS. 2 and 3, a connection of the torsional coupling 28 to the engine damper 16 is facilitated by using fasteners, such as threaded fasteners 60 (FIG. 3). In this manner, the torsional coupling 28 is removably connected with the engine damper 16. In an embodiment, the engine damper 16 may include a recess or a holding portion 62 (FIG. 2), which facilitates a fixed accommodation of the torsional coupling 28 relative to the engine damper 16. Also, the torsional coupling 28 may include a number of apertures 64 that are coaxially positioned against threaded openings 66 (FIG. 2) provided on the holding portion 62 (FIG. 2) of the engine damper 16. The apertures 64 are configured to receive threaded fasteners 60 (FIG. 3), which enable the torsional coupling 28 to be fixedly engaged with the holding portion 62. Such fixed engagement allows the torsional coupling 28 to rotate with the engine damper 16.

The torsional coupling 28 includes a shaft-receiving portion 68 to which the first end 36 of the driveshaft 24 is connected, and in turn, a connection between the driveshaft 24 and the engine damper 16 is established. Moreover, the shaft-receiving portion 68 includes an insert 70 with counter grooves 72 (FIG. 3), which may be adapted to match and complement the splined grooves 40 of the driveshaft 24, so as to establish a fixed connection between the driveshaft 24 and the engine damper 16.

As best shown in FIG. 3, the torsional coupling 28 is generally made of a resilient material, which is captured in a generally rigid surrounding structure. As an example, the resilient material may be rubber or a polymer-based material, which is adapted to withstand shocks and vibrations of the engine 14's operation, as will hereinafter be described. The torsional coupling 28 includes equidistantly spaced first wedge portions 74 that are sandwiched between the resilient material or second wedge portions 76. The first wedge portions 74 are generally rigid structures that include fasteners referred to as set screws 78. The set screws 78 are generally radially and extending fasteners that inwardly capture a splined insert 70 (or simply insert 70) of the torsional coupling 28, and, in turn, capture an outer portion of the first end 36 of the driveshaft 24. The insert 70 forms an interface between the set screws 78 and the first end 36. In this manner, the radiator fan 20 and driveline assembly 10 may be assembled to the engine 14 via the torsional coupling 28. The set screws 78 are appropriately tightened to rigidly fasten the insert 70 in the shaft-receiving portion 68. In so doing, the insert 70 is generally co-axial with the engine damper 16, along the longitudinal axis 30.

As an exemplary installation procedure, an assembly of the driveline assembly 10 relative to the engine 14 is enabled by first establishing a transversal engagement of the frame section 54 relative to the base frame 18. Thereafter, the base member 52 may be mounted to the frame section 54, onto which platforms 56 and 58 are mounted. The pillow blocks 32 and 34 are then in turn mounted to the platforms 56 and 58, and are fixedly connected relative to the base frame 18. This facilitates the mounting of the driveline assembly 10 to the base frame 18. In so doing, the driveline assembly 10 acquires a sound operable relation relative to the engine 14, as both the engine 14 and the driveline assembly 10 are set up on the same foundation. Therefore, an operable connection of the engine 14 to the radiator fan 20 is enabled.

### INDUSTRIAL APPLICABILITY

In operation, the engine 14 may drive the engine damper 16. As a result, the engine damper 16 transmits the engine 14's power to the torsional coupling 28. As the set screws 78 are appropriately tightened to rigidly fasten the insert 70, the insert 70 co-axially rotates with the torsional coupling 28. Given the splined and fixed engagement between the insert 70 and the first end 36 (FIG. 1) of the driveshaft 24, a rotation of the insert 70 in turn leads to a rotation of the driveshaft 24. As a result, the engine damper 16 transfers torque to the driveshaft 24. The pillow blocks 32 and 34 support the driveshaft 24, and enable the driveshaft 24 to be rotated about the longitudinal axis 30. This rotation of the driveshaft 24 is enabled with an absence of wobble and undue shaft run-out, thus enabling a reliable transmission of motion, accompanied with substantially lesser effort required by the engine 14. Because the driveshaft 24 is connected to the drive pulley 44, the engine damper 16 transmits rotary motion to the drive pulley 44, and, thus, causes an operation of the belt drive 26. This leads to the functioning of the radiator fan 20.

Since the present disclosure avoids the usage of a cardan shaft, an installation of the driveline assembly 10 may be performed separately from an assembly of the engine 14. Moreover, workability associated with the alignment of a generally twin-axes cardan shaft is resolved, as the driveshaft 24 constitutes a single axis configuration. As a result, considerable assembly time and effort is saved. The single axes configuration of the driveshaft 24 also facilitates the driveline assembly 10 to occupy relatively less space than cardan shaft-based applications. Moreover, incorporation of first wedge portions 74 enables the torsional coupling 28 to effectively transfer torque to the driveshaft 24, while resilient second wedge portions 76 work to cushion the stresses that accompany conventional engine operations. Furthermore, the inclusion of the resilient second wedge portions 76 allows the torsional coupling 28 to be relatively lightweight and simple in construction, and is considerably inexpensive to manufacture and maintain as well.

Additionally, a linearly configured power-transmitting shaft, such as the driveshaft 24, exceeds in reliability against a split-axis shaft design, such as cardan shafts. This is because a rotary movement of the driveshaft 24 is enabled about a singular longitudinal axis 30, and, therefore, the driveshaft 24's movement is relatively simpler. Accordingly, there is lesser load of operation involved. As a result, shaft deformation and fracture is only minimally sustained. Further, in an embodiment, the driveline assembly 10 may drive multiple sub-systems of the engine 14, alongside the radiator fan 20. Therefore, a focus of the present disclosure to an application involving a drive of the radiator fan 20 need not be seen as limiting in any way.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A driveline assembly for an engine, the engine having an engine damper and a base frame, the engine being mounted on the base frame, the driveline assembly comprising:
a torsional coupling have alternating wedge portions with first wedge portions and second wedge portions, wherein the first wedge portions include a rigid structure and the second wedge portions include a resilient structure;
a guide assembly including:
at least one pillow block mounted to the base frame;
a driveshaft with a first end and a second end, the first end being connected to the engine damper via the torsional coupling, the driveshaft being rotatably supported by the at least one pillow block,
wherein the first wedge portions include radially extending fasteners to capture an outer portion of the first end of the driveshaft; and
a belt drive with a drive pulley, wherein the drive pulley is connected to the second end of the driveshaft.
